(19) United States
(12) Patent Application Publication
(10) Pub. No.: US 2001/0052912 A1
(43) Pub. Date: Dec. 20, 2001

(54) Multifunction switch device with display function

(75) Inventors: Koji Ishii, Shizuoka (JP); Masayuki Ogawa, Shizuoka (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Yazaki Corporation, Tokyo (JP)

(21) Appl. No.: 09/859,473

(22) Filed: May 18, 2001

(30) Foreign Application Priority Data
Jun. 19, 2000 (JP) 2000-182714

(51) Int. Cl. G06F 3/00

(52) U.S. Cl. 345/835; 345/810

(57) ABSTRACT

A multifunction switch device with a display function is provided, by which a plurality of functions can be selected with a single switching operation so that a degree of freedom for assigning functions to each switch is increased and the selected function can be easily seen. An icon CR1 of TV is displayed using an animation on a screen of the left side switch MF1a out of a MF switches MF1, while an icon CR2 of CD as an equipment presently selected is displayed using an animation on a screen of the right side switch MF1b, and in addition, a letter “CD” and a letter “MD” are seen at right and left under the icon CR2. If a CD player is an equipment presently selected, a letter “CD” is displayed to be white in a black background, while a letter “MD” indicating a MD player to be selected next is displayed with a normal displaying image.

### BACKGROUND OF THE INVENTION

(1) Field of the Invention

This invention relates to a multifunction switch device with a display function, which displays a function of a switch by using characters on an image displaying section provided at a switch operating section, and more specifically, to a multifunction switch device with a display function, which displays characters corresponding to functions varied in response to an operating direction of the switch on the image displaying section.

(2) Description of the Related Art

An electric equipment centralized at a center console of a vehicle, such as a car stereo and other audio equipment, needs an operating button for selecting an action, and so far each operating button for a respective electric equipment is separately prepared and arranged on the center console of a vehicle.

However, the function of each electric equipment has been diversified according to the technological progress, which in turn has increased the number of the buttons needed. Therefore, it has gradually become difficult to arrange all the buttons needed on a center console, which has a limited space. In addition, many operating buttons may do damage to a fine sight of the center console.

In order to solve the problems mentioned above, for example, there has been proposed an electronic equipment, in which a liquid crystal display is arranged at the rear of an operating button and the display of the liquid crystal display is changed so as to change a function display of the operating button, which can be seen through a transparent part or a through hole of the operating button.

As shown in a plan view of FIG. 6A, there is an operation button, in which a seesaw switch is employed at a switch part. This operation button is provided with rotating shafts J1 and J2 in the upper and lower directions from the center toward the outside in the back of a key-top KT, which is made of transparent acrylic resin and the like and is partially exposed on the surface of a switching panel (not shown in the figure). The key-top is rotatably held on the back of the switching panel by these rotating shafts J1 and J2.

As shown in a sectional view of FIG. 6B, on the back of the key-top KT, a pair of projections T1 and T2, each end of which is molded in a L letter-shape downward from the side on which one rotating shaft J2 is formed, are integrally formed at right and left with the key-top KT putting the rotating shaft J2 therebetween. On the back of the key-top, there is arranged a liquid crystal display DP, which displays images shown in FIGS. 5A and 5B, on a circuit board (not shown in the figure) at a position where an interference with the projections J1 and J2 can be avoided, putting a predetermined distance from the key-top KT. In addition, under projections J1 and J2 there are arranged limiting switchs SW1 and SW2, respectively, which become ON when one end of the key-top KT is pressed, on the circuit board.

As to an operation of the operating button, an image is displayed on the liquid crystal display DP as shown in FIG. 5A. When a position of a symbol SY2 indicated by “>” displayed on the surface of the key-top KT is repeatedly pressed, a receiving frequency of a car radio changes to the UP direction, on the other hand, when a position of a symbol SY1 indicated by “<” is repeatedly pressed, a receiving frequency of a car radio changes to the DOWN direction.

Another image is displayed on the liquid crystal display DP as shown in FIG. 5B. When a position of a symbol SY2 indicated by “+” displayed on the surface of the key-top KT is repeatedly pressed, the volume of an audio equipment changes to the UP direction, on the other hand, when a position of a symbol SY1 indicated by “−” is repeatedly pressed, the volume of an audio equipment changes to the DOWN direction.

In a conventional multifunction switch device with a display function, in which a seesaw switch is employed at the switch part, mutually related functions, for example the UP and DOWN functions, must be provided because an operating object becomes hard to see when the switch is operated in the right or the left direction.

However, when the mutually related functions are provided, in a multifunction switch device, which has to operate many kinds of equipement with a small number of switches, a degree of freedom for assigning functions to each switch is decreased, causing a problem that the multifunction switch device cannnot sufficiently fulfill the function thereof.

### SUMMARY OF THE INVENTION

It is therefore an objective of the present invention to solve the above problem and to provide a multifunction switch device with a display function, by which a plurality of functions can be selected with a single switching operation and the selected function can be easily seen.

In order to attain the above objective, the present invention is to provide a multifunction switch device with a display function, as shown in a basic constitution of FIG. 1, comprising: a switch section MF1-MF4 for newly selecting an operating object equipment whenever an switching operation is carried out; a displaying section DP1-DP4 for displaying a character indicating an operating object equipment to be selected at each operation area on a switch operating part in the switch section MF1-MF4; switching operation detecting means 13c for detecting an operated area out of said each operation area; operating object detecting means 13a for detecting an operating object equipment; and image generating means 13b for generating a character indicating an operating object equipment on the basis of a detected result by the operating object detecting means 13a and sending the character to the displaying section DP1-DP4, and for renewing a displaying image of the character displayed at the displaying section DP1-DP4 on the basis of a detected result by the switching operation detecting means 13c, wherein on the basis of a detected result by the switching operation detecting means 13c, the image generating means 13b makes the displaying section DP1-DP4 display the character so that a character indicating a different operating object equipment is displayed on each adjacent operation area.

According to the constitution described above, a degree of freedom for assigning functions to each switch is increased, resulting in that a function as a multifunction switch device is sufficiently fulfilled.

The switch section MF1-MF4 employs a seesaw switch for a switching mechanism thereof and the displaying section DP1-DP4 displays a character, displayed contents of which increases whenever one operation area is operated and decreases whenever another operation area is operated, extending over both said one and another operation areas.

According to the constitution described above, a character can be displayed with dimensions that secures an excellent visibility.

The switch section MF1-MF4 employs a seesaw switch for a switching mechanism thereof, the displaying section DP1-DP4 displays a character indicating an operating object equipment at one operation area and displays a character indicating a different operating object equipment presently selected from said operating object equipment together with a character indicating an operating object equipment to be selected next at another operation area, and said another operation area is repeatedly operated, thereby an operating object equipment is switched.

According to the constitution described above, a degree of freedom for assigning functions to each switch is further increased, resulting in that a function as a multifunction switch device is sufficiently fulfilled.

### BRIEF DESCRIPTION OF THE DRAWINGS

FIG. 1 illustrates a basic constitution of a multifunction switch device with a display function according to the present invention;

FIG. 2 is a perspective view illustrating a vehicle dashboard including a center console, to which the multifunction switch device with a display function according to the present invention can be applied;

FIG. 3 is a front view illustrating a primary part of an integrated panel employing a multifunction switch device with a display function according to a first preferred embodiment of the present invention;

Each of FIGS. 4A-4C illustrates an example of image displaying by a multifunction switch device employing a seesaw switch according to the present invention;

Each of FIGS. 5A and 5B illustrates an example of image displaying by a conventional multifunction switch device employing a seesaw switch;

FIG. 6A is a plan view of a multifunction switch device employing a seesaw switch;

FIG. 6B is a sectional view of a multifunction switch device employing a seesaw switch;

FIG. 7 illustrates an operation flow of the integrated panel shown in FIG. 3;

FIG. 8 is a block diagram illustrating an electrical constitution of a multifunction switch device with a display function according to the present invention;

FIG. 9 is a flow chart illustrating a processing, which is carried out by a CPU according to a controlling program installed in a ROM of the microcomputer shown in FIG. 8; and

FIG. 10 is a flow chart illustrating a processing, which is carried out by a CPU according to a controlling program installed in a ROM of the microcomputer shown in FIG. 8.

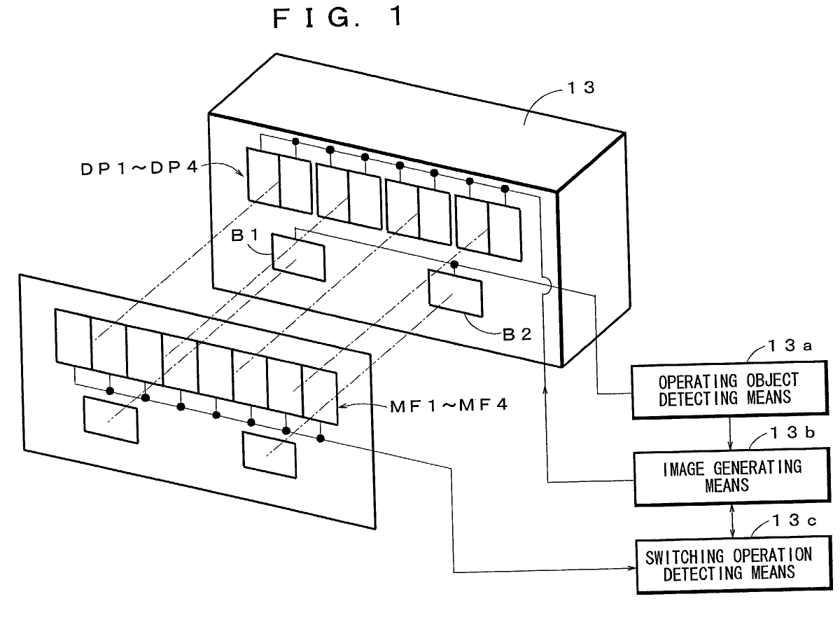

### DESCRIPTION OF THE PREFERRED EMBODIMENTS

(First Preferred Embodiment)

In the following, a multifunction switch device with a display function according to a first preferred embodiment of the present invention will be explained with reference to the attached drawings. Hereinafter, “a multifunction switch device with a display function” is simply called as “switch device”.

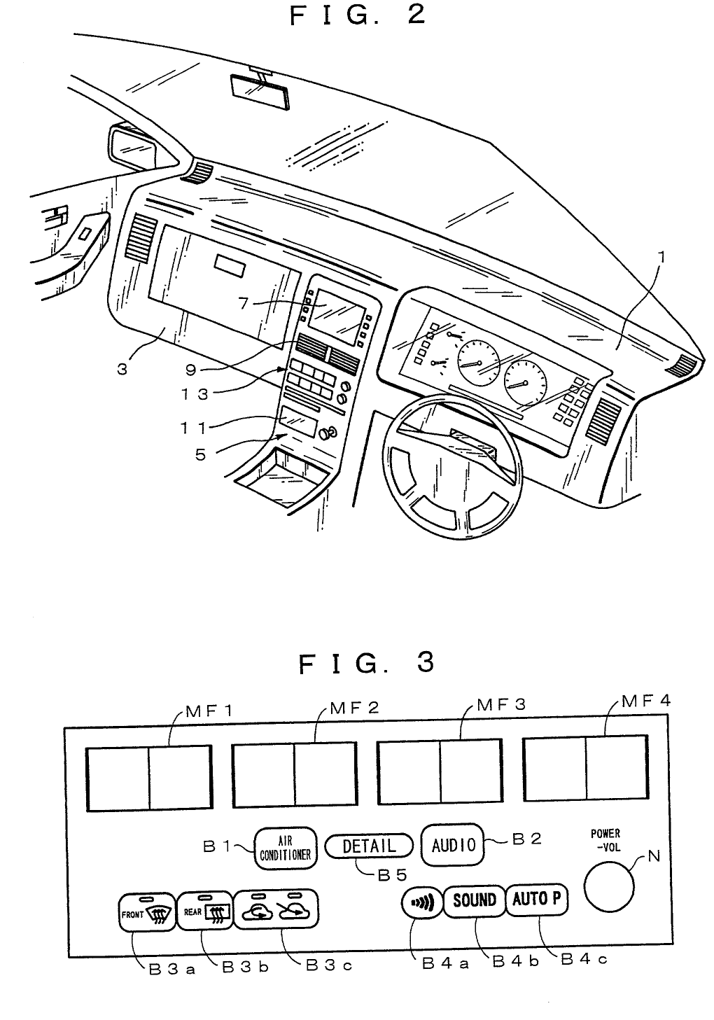

To begin with, an example of the object, to which the switch device according to the present invention is applied, will be explained with reference to FIG. 2.

FIG. 2 is a perspective view illustrating a vehicle dashboard including a center console, to which the switch device according to the present invention can be applied. In FIG. 2, the reference numeral 1 indicates a dashboard and 3 indicates an instrument panel. At the central portion of the instrument panel 3 in the width direction of the vehicle, there is disposed a center console 5. In the center console 5, there are integrated a display screen 7 for the navigation and the integrated panel 13 constituting a switch device according to the first preferred embodiment, which is put above and below between an outlet 9 of an air-conditioner and an ashtray 11.

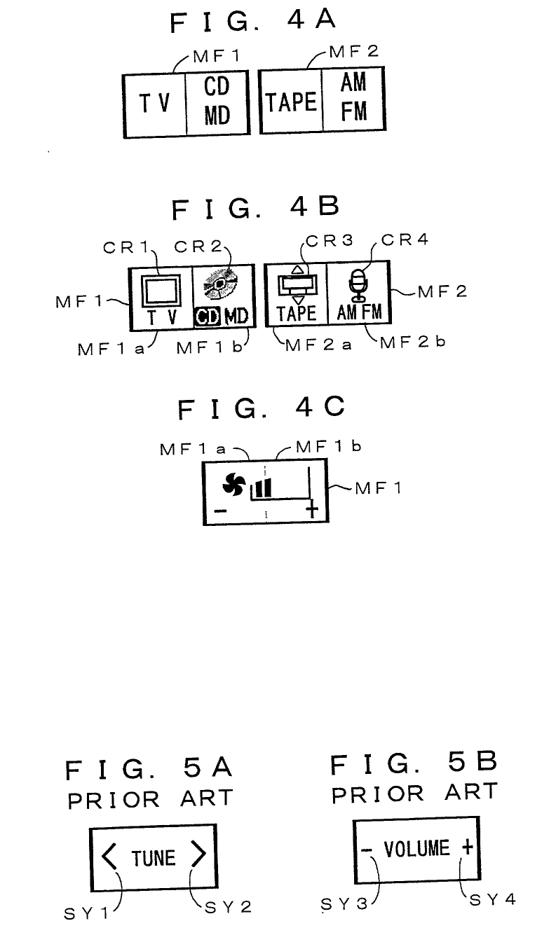

As shown in FIG. 3, in the integrated panel 13, multifunction switches MF1-MF4 (hereinafter, being given a brief account of MF switch) with a display function are arranged in the upper row of the panel, an operation button B1 for changing a screen of the MF switch to an air conditioner mode and an operation button B2 for changing the screen of the MF switch to an audio mode are arranged in the middle row of the panel, a set of three operation buttons B3a-B3c of the air conditioner mode, on each of which a symbol mark indicating a respective equipment to be selected, such as “defogger”, “rear window heater” and “air circulation and ventilation”, can be seen, are arranged at left in the lower row of the panel, and a set of three operation buttons B4a-B4c, in which the button B4a has a symbol mark indicating a traffic information, the mode button B4b is for selecting a sound mode for setting timbre and sound field, and the automatic presetting button B4c is for automatically providing receivable broadcasting stations, are arranged at right in the lower row of the panel. In addition, a knob N for sound volume controlling and power switching is arranged right next to the presetting button B4c.

On the screen, which is used as a key-top as well, of the MF switch MF1 according to the first preferred embodiment, when the button B2 for operating audio equipments is set ON to make the screen in the audio displaying mode, as shown in FIG. 4A, a letter indicating an selected object equipment, i.e. TV, is displayed at the left side of the screen through the display by the liquid crystal display DP, while two letters indicating selected object equipments, i.e. CD and MD players, are displayed lengthwise at the right side of the screen through the display by the liquid crystal display DP.

Similarly, a letter “TAPE” indicating an selected object equipment, i.e. casette recorder, is displayed at the left side of the screen through the display by the liquid crystal display DP, while two letters “AM” and “FM” indicating a selected object equipment, i.e. car radio, are displayed lengthwise at the right side of the screen through the display by the liquid crystal display DP. As to an image of the letters displayed on each MF switch, an image of the letter indicating an equipment presently selected is set different from that of the letter indicating an equipment to be selected next.

When the button B1 for operating an air conditioner is set ON to make the screen in the air conditioner displaying mode, as shown in FIG. 4C, a letter “−” indicating an operation symbol for decreasing the ventilation level is seen on the screen at the left switch MF1a side of the MF switch MF1, while a letter “+” indicating an operation symbol for increasing the ventilation level is seen on the screen at the right switch MF1b side of the MF switch MF1. In addition, a symbol mark “ventilation level” is seen on the screen, the displaying contents of which changes with the change in actual ventilation level.

Actually on the screen, as shown in FIG. 4B, an icon CR1 of TV is seen at the left side switch MF1a of the MF switch MF1, while an icon CR2 of CD is seen in an animation at the right side switch MF1b of the MF switch MF1. Letters “CD” and “MD” are seen at left and right under the icon CR2.

When the CD player is an equipment presently selected, the letter “CD” is displayed to be white in a black background, while the letter “MD” indicating an equipment to be selected next is displayed in a normal displaying image. Since the TV is presently not a candidate for selection, the displaying image of the icon CR1 is displayed as a stationary image by using a wire frame displaying.

On the screen corresponding to each switch MF2a and MF2b of the MF switch MF2, an icon CR3 illustrating a cassete insertion opening in a stationary image and an icon CR4 illustrating a mike, respectively, are displayed. In addition, a letter “TAPE” is seen under the icon CR3, while letters “AM” and “FM” are seen at left and right under the icon CR4.

Thus, an audio equipment such as the TV, CD player, MD player, cassette player and car radio, which is selectable and presently connected to the switch device, is seen with the icon and the letter on each screen. An equipment presently selected is displayed in an animation, while an equipment not selected is displayed with a stationary image thereof.

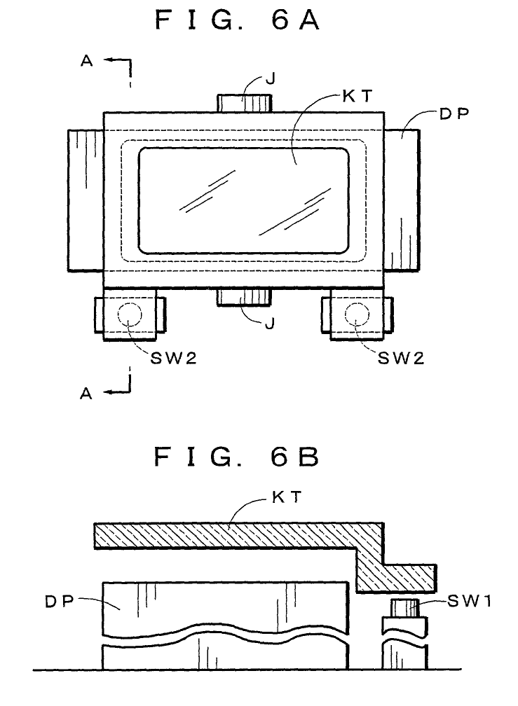

A seesaw switch shown in FIG. 6 is employed for the MF switches MF1-MF3, thereby at least three kinds of selectable equipment can be set up with a single MF switch.

That is, as shown in FIG. 4B, the icon CR1 of TV that is selectable and presently connected to the switch device is displayed in a stationary image on the screen corresponding to the left side switch MF1a of the MF switch MF1, while the letter “TV” is displayed under the icon CR1.

Then, the icon CR2 of CD player that is selectable and presently connected to the switch device is displayed in an animation on the screen corresponding to the right side switch MF1b, and in addition, the letter “CD” is displayed and the letter “MD” to be selectable next is seen right next to the letter “CD” in a different displaying image from that of the letter “CD”.

As a result, the CD player can be in operation out of a plurality of the car audio equipments. However, when the position at the CR1 of TV icon displayed in a stationary image thereof is pressed, the limiting switch SW1 (see FIG. 6A) corresponding to the left side switch MF1a is set ON, thereby the icon CR1 of TV is displayed in an animation and the letter “TV” displayed under the icon CR1 is displayed to be while in a black background. On the other hand, the icon CR2 of CD displayed on the screen corresponding to the right side switch MF1b is changed to a stationary image thereof and the letter “CD” is changed to the normal displaying image.

When the right switch is pressed again in a state that the CD player is presently selected, the icon CR2 is changed to MD in an animation image thereof, the letter “MD” is displayed to be while in a black background, and the letter “CD” is changed to the normal displaying image. That is, when the right side switch is repeatedly pressed, an equipment presently selected is switched to an equipment to be selected next whenever the switch is pressed.

Similarly, as to the MF switch MF2, when the right side switch MF2b is repeatedly pressed, an equipment presently selected is switched to an equipment to be selected next whenever the switch is pressed, for example from the receiving of AM broadcasting to the receiving of FM broadcasting or inversely. At this time, the icon CR4 of mike is displayed in an animation while the icon CR3 of cassette tape is displayed in a stationary image.

When the icon CR3 of cassette tape is pressed, the icon CR3 is displayed in an animation while that of mike is switched to a stationary iamge.

As a result, a degree of freedom for assigning functions to each switch is increased, resulting in that a function as a multifunction switch device is sufficiently fulfilled.

In the following, an electrical constitution of a multifunction switch device with a display function according to the first preferred embodiment will be explained.

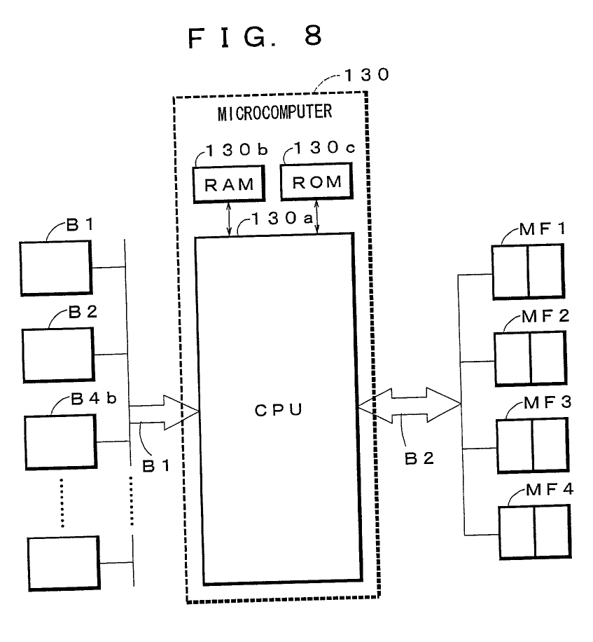

As shown in FIG. 8, in the multifunction switch device with a display function according to the first preferred embodiment, a microcomputer 130, which controls the display DP in the MF switches MF1-MF4 as described above according to the pressing operation of the limiting switches SW1 and SW2 constituting the MF switch, consists of a CPU 130a, RAM 130b and ROM 130c.

The operation buttons B1, B2 and B3, which output a signal for the CPU16a to make reservations of timbre setting function of the audio equipments, are connected to each input port via a common bus CB1. The input/output ports of the CPU16a are connected to the displaying device DP of the MF switches MF1-MF4 corresponding to each selectable object and each limiting switch SW1 and SW2 via the common bus CB1.

In the RAM 130b, there is provided a working area for use in a data area and in various processings. The working area is provided with an area and the like for use of various flags and buffers. In the ROM 130c, there is installed a controlling program for the CPU 130a to exert various processing.

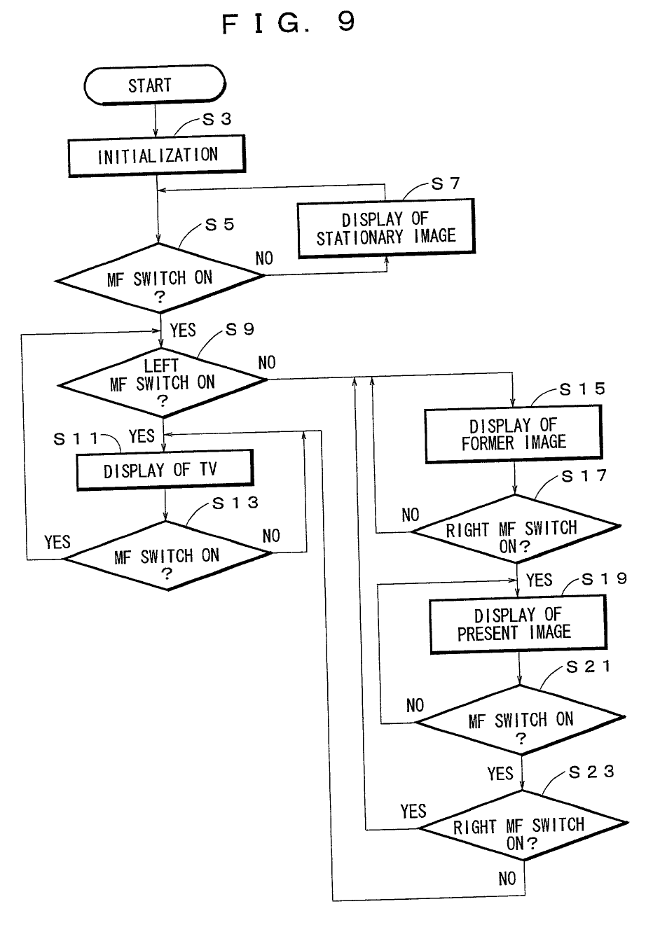

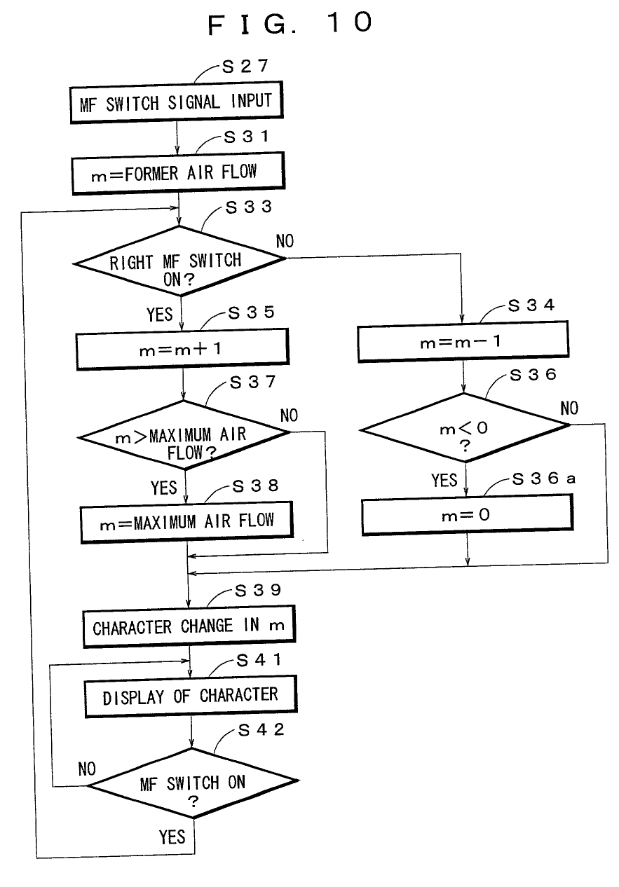

In the following, processings carried out by CPU 130a according to the controlling program installed in the ROM 130c will be explained with reference to flow charts shown in FIGS. 9 and 10.

A flow chart shown in FIG. 9 illustrates a display control processing in response to the selection of the functions shown in FIG. 4B.

By switching on an accessory switch (not shown in the figure), the microcomputer 130 is supplied an electric power from a battery (not shown in the figure) and the like, which is loaded on a vehicle, and is started to start a program, then the CPU 130a sets the various flag areas of the RAM 130b to be “0” and inputs a signal via an input port from each operation button B1-B3, thereby judging a function to be selected. As a result of the judgement, when the selectable function is, for example, CD player, MD player, cassette tape recorder, car radio and TV, if a certain equipment is set to be an equipment presently selected, an equipment to be selected next is determined with respect to the certain equipment, and an initial setting including the determination of the selection sequence is carried out (step S3).

As the selection sequence, for example, as shown in FIGS. 4A and 4B, when an equipment presently selected is set to be the CD player, an equipment to be selected next is set to be the MD player. When a radio broadcasting presently selected is set to be AM broadcasting, a radio broadcasting to be selected next is set to be FM broadcasting After the function selecting sequence is determined as described above, as shown in FIG. 5B, the icons CR1-CR4 of the TV, CD, cassette tape and mike are displayed in a stationary image on the respective display DP corresponding to the respective switch MF1a, MF1b, MF2a and MF2b.

Then, it is judged whether or not one of the MF switches MF1-MF4 is in ON operation (step S5). If judged not ON, each icon is displayed in a stationary image (step S7), then an ON signal input of the MF switch is checked again.

At this time, if the MF switch MF1 is judged ON, the left side switch MF1a of the MF switch MF1 is judged whether or not ON. If judged ON, the icon CR1 of TV is displayed in an animation on the display DP, thereby the driver can see that the presently selected equipment is TV (step S11). Then, the MF switch MF1 is judged whether or not ON, and if judged not ON, the display DP keeps displaying the icon CR1 of TV in an animation (step S11).

On the other hand, when the operation of MF switch MF1 is judged ON (step S13), the system returns to the step S9 and it is judged whether or not the left side switch is ON. When judged not ON, the right side switch MF1b displays, for example, the icon CR2 of CD in an animation, which has been displayed in an animation the last time. In addition, the letter “CD” is switched to the letter “MD” indicating MD player, i.e. an equipment to be selected next, and displayed under the icon CR2 with a different displaying image (step S15), while the icon CR1 of TV is changed into a stationary image.

Then, an ON operation of the right side switch MF1b is checked, and if checked not ON, the display DP keeps displaying the icon CR2 of CD in an animation image (steps S17, S15). On the other hand, if checked ON (step S21), the icon CR2 is switched to MD, which is a displaying image this time, in an animation image (step S19), while a function to be selected next is switched to CD.

Next, an ON operation of the MF switch MF1 is checked, and if checked not ON, the displaying of the icon of CD in an animation image is kept (steps S21, S19). On the other hand, if checked ON, it is judged whether or not the right side MF switch MF1b is in an ON operation (step S23). If judged ON, the icon displaying of CD in an animation image is switched to the icon displaying of MD (step S23).

However, when the left side MF switch MF1a is judged in an ON operation, an equipment presently selected is switched to TV, therefore the icon displaying in an animation image is switched to TV (step S11).

As a result, a degree of freedom for assigning functions to each switch is increased.

(Second Preferred Embodiment)

In the explanation of the first preferred embodiment, the processing for the selection of the equipments and that for switching of the display indicating the selected equipment are explained. A processing for switching of the display according to a second preferred embodiment is that the operation button B1 shown in FIG. 3 is pressed to select the air conditioner mode, as shown in FIG. 4C the symbol of “ventilation level” is displayed on a whole screen of the display of the MF switch MF1, and a form of the symbol is changed to be increasing or decreasing whenever the MF switch MF1 is pressed, thereby the change in the ventilation level is to be seen.

According to the second preferred embodiment, the image of the air conditioner mode, in which the symbol mark of “ventilation level” is seen, is displayed on a whole screen of the display of the MF switch MF1, thereby the symbol mark can be displayed with a dimension that secures an excellent visibility.

In the following, an operation according to the second preferred embodiment will be explained with reference to a flow chart shown in FIG. 10.

As an initial setting, an input from the MF switch MF1, on which the symbol mark of “ventilation level” is displayed, is detected and the former air flow is set up in a register m, which tentatively memorizes an additional value of the ventilation level (steps S27, S31).

After the setting of the air flow is finished, by pressing a position of “+” displayed on the key-top KT, the limit switch SW2, which is the right side switch MF1b of the MF switch MF1, judges whether or not an operation is ON (step S33). When the right side switch MF1b is repeatedly operated to be ON, the air flow increases. If the right side switch MF1b is judged to be ON, 1 is added to the m (i.e. the former air flow) (step S35). As a result of the addition, it is judged whether or not the air flow m is larger than the predetermined maximum air flow (step S37). If judged larger, the content of the register m is replaced by the maximum air flow (step S38).

Then, the content of the register m is replaced by a plurality of characters of longitudinal bars indicating the maximum air flow (step S39). The replaced characters are displayed on the display DP and seen through the key-top KT (step S41).

On the other hand, if judged not larger at the step S37, the added result at the step S35 is replaced by a plurality of characters of longitudinal bars indicating the air flow (step S39) and displayed on the display DP (step S39).

When the character is displayed, the ON operation of the MF switch MF1 is checked again and then, if not judged ON, the present character displaying is kept. However, the driver of the vehicle repeatedly presses the position of “+” displayed on the key-top KT in order to increase the air flow up to the maximum air flow, the steps S35, S37, S39, S41 and S42 are repeated whenever the right side switch MF1b is judged ON at the step S33, then the characters of longitudinal bars having the length indicating the air flow are displayed in turn.

On the other hand, when the driver of the vehicle repeatedly presses the position of “−” displayed on the key-top KT in order to decrease the air flow, the limiting switch SW1, which is the left side switch MF1a of the MF switch MF1, is in an ON operation, and an ON signal is input into the CPU 130a, thereby an ON operation of the left side switch MF1a is judged (step S33). As a result of the ON operation judgement, 1 is subtracted from the value installed in the register m (step S34), then it is judged whether or not the subtracted result is smaller than 0 (step S36). If judged smaller, the content of the register m is set 0 (step S36a). This subtracted result is replaced by the characters (step S39) and then, out of the characters displayed, a character that accords with the subtracted result is displayed (step S41).

When the driver of the vehicle repeatedly presses the position of “−” displayed on the key-top KT in order to decrease the air flow to “1”, the steps S34, S36, S36a, S39, S41 and S42 are repeated whenever the left side switch MF1a is judged ON at the step S33. As a result, the characters displayed are replaced in turn by the characters of longitudinal bars having the length indicating the decrease in air flow.

(Third Preferred Embodiment)

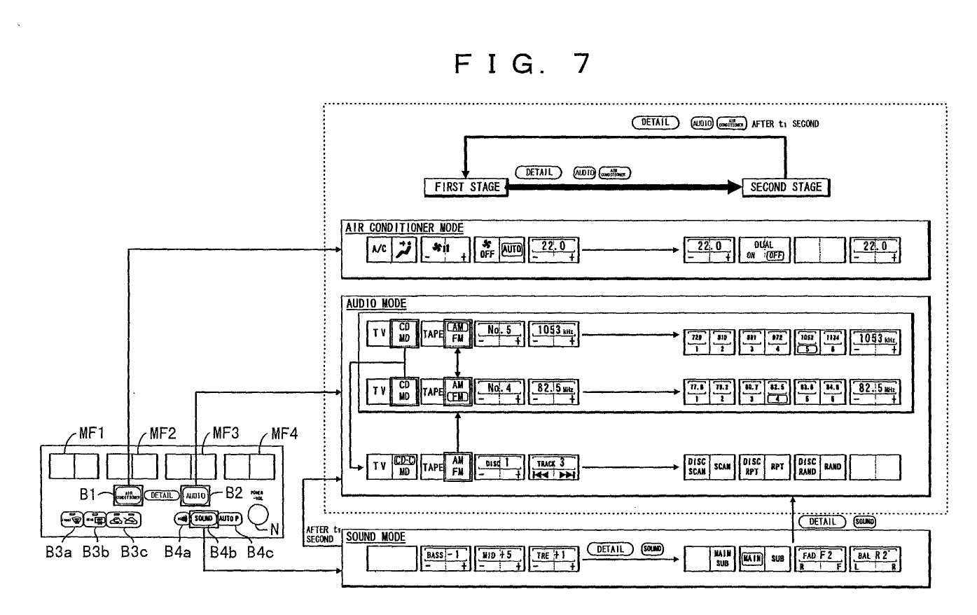

In the following, an opertion flow of the integrated panel employing the switch device according to the present invention will be explained with reference to FIG. 7.

For example, when the operation button B1 is set ON, each display DP of the MF switches MF1-MF4 displays the images in the air conditioner mode in a first stage.

As to the displaying content of each display of the MF switches MF1-MF4 in the air conditioner mode, a letter “A/C” indicating the air conditioner and a symbol mark indicating the ventilation function for ventilating only to the head are displayed adjacently on the switch MF1, a symbol of the ventilation level is displayed on the whole screen of the switch MF2, a symbol indicating the stop of the ventilation and a symbol indicating the automatic air conditioner are displayed adjacently on the switch MF3, and an image for adjusting the interior temperature of the vehicle is displayed on the whole screen of the switch MF4.

As to an image display of a second stage, which is selected followed by an image display of the first stage by using a button B5 for selecting the stage, an image for adjusting the interior temperature of the vehicle is displayed on each whole screen of the switches MF1 and MF4. An image for controlling the DUAL in ON/OFF is displayed on the whole screen of the switch MF2.

Especially, as for the MF switches MF1 and MF3 in the first stage, different functions can be mutually selected with a single MF switch.

When the operation button B2 is set ON, each display DP of the MF switches MF1-MF4 displays the images in the audio mode in the first stage.

As to the displaying content of each display of the MF switches MF1-MF4 in the audio mode, for example, on the switch MF1, a letter “TV” indicating the selected equipment TV is displayed and letters “CD” and “MD” indicating the respective equipment to be selected when the right side of the switch is repeatedly pressed are displayed upper and lower adjacently to right next to the letter “TV”. On the switch MF2, a letter “TAPE” indicating the selected equipment cassette recorder is displayed and letters “AM” and “FM” indicating the radio broadcasting to be selected when the right side of the switch is repeatedly pressed are displayed upper and lower adjacently to right next to the letter “TAPE”. On the whole screen of the switch MF3, an image for changing a presetting number is displayed. On the whole screen of the switch MF4, an image for adjusting the receiving frequency of AM broadcasting is displayed.

As to an image display of a second stage, which is selected followed by an image display of the first stage by using a button B5 for selecting the stage, two presetting frequencies are displayed together with the presetting numbers on each screen of the switches MF1 to MF3. An image for adjusting the receiving frequency of AM broadcasting is displayed on the whole screen of the switch MF4.

Especially, as for the MF switches MF1 and MF2 in the first stage, different functions can be mutually selected with a single MF switch.

When the operation button B3 is set ON, each display DP of the MF switches MF1-MF4 displays the images in the sound mode in the first stage.

As to the displaying content of each display of the MF switches MF1-MF4 in the sound mode, for example, the switch MF1 does not display an image, while the switches MF2 to MF4 display images for adjusting the lower register (BASS), middle register (MID) and upper register (TRE), respectively, on the respective whole screen.

As to an image display of a second stage, which is selected followed by an image display of the first stage by using a button B5 for selecting the stage, on the switches MF1 and MF2, images of main sound and sub-sound and an image for selecting the main sound and sub-sound are displayed upon selecting TV, while on the switch MF3, an image for adjusting a balance between the sound volume of the rear speakers and that of the front speakers in the vehicle is displayed.

What is claimed is:

1. A multifunction switch device with a display function comprising:
a switch section, for newly selecting an operating object equipment whenever an switching operation is carried out;
a displaying section for displaying a character indicating an operating object equipment to be selected at each operation area on a switch operating part in the switch section;
switching operation detecting means for detecting an operated area out of said each operation area;
operating object detecting means for detecting an operating object equipment; and
image generating means for generating a character indicating an operating object equipment on the basis of a detected result by the operating object detecting means and sending the character to the displaying section, and for renewing a displaying image of the character displayed at the displaying section on the basis of a detected result by the switching operation detecting means,
wherein on the basis of a detected result by the switching operation detecting means, the image generating means makes the displaying section display the character so that a character indicating a different operating object equipment is displayed on each adjacent operation area.

2. The multifunction switch device with a display function according to claim 1, wherein the switch section employs a seesaw switch for a switching mechanism thereof and the displaying section displays a character, displayed contents of which increases whenever one operation area is operated and decreases whenever another operation area is operated, extending over both said one and another operation areas.

3. The multifunction switch device with a display function according to claim 1, wherein the switch section employs a seesaw switch for a switching mechanism thereof, the displaying section displays a character indicating an operating object equipment at one operation area and displays a character indicating a different operating object equipment presently selected from said operating object equipment together with a character indicating an operating object equipment to be selected next at another operation area, and said another operation area is repeatedly operated, thereby an operating object equipment is switched.
